(19) United States
(12) Patent Application Publication
(10) Pub. No.: US 2003/0057007 A1
(43) Pub. Date: Mar. 27, 2003

(54) Front axle disconnect apparatus

(76) Inventor: David F. Stevens, Boring, OR (US)

Correspondence Address: Alfred F. Hoyte, Jr., 7734 16TH ST., N.W., WASHINGTON, DC, 20012, US

(21) Appl. No.: 09/956,951

(22) Filed: Sep. 21, 2001

(51) Int. Cl. B60K 17/354

(52) U.S. Cl. 180/247

(57) ABSTRACT

An apparatus for automatically controlling the number of drive wheels to which power is applied in accordance with the range in which the transfer case is operated. In the low range of operation, including reverse, the drive power is supplied solely to the rear wheels. In the higher range, the number of drive wheels to which drive power is applied is in accordance with the operator settings. A pair of, for example, locking hubs that are actuated by vacuum, air or hydraulic power appropriately routed to the wheels and controlled by an electrically driven valve is operated, in conjunction with the transmission or transfer case shifting mechanism. The arrangement provides a means for automatically reducing the stress on the transmission and transfer case when the vehicle is operated in the four wheel drive mode.

### BACKGROUND OF THE INVENTION

This invention relates generally to an apparatus for disconnecting two of the drive wheels of a four wheel drive vehicle, and is specifically related to an apparatus for automatically disconnecting two of the drive wheels of a four wheel drive vehicle in response to certain predetermined conditions.

### STATEMENT OF THE PRIOR ART

The present invention relates to a power transfer system for controlling the application of drive power between the front and rear wheels of a four-wheel drive vehicle as a function of predetermined operator-initiated inputs.

With the increased popularity of four-wheel drive vehicles, a plethora of power transfer systems are currently being utilized in vehicular drivetrain applications for selectively directing drive power (i.e., drive torque) to the non-driven wheels of the vehicle. In many power transfer systems, a part-time transfer case is incorporated into the drivetrain and is normally operable in a two-wheel drive mode for delivering drive torque to the driven wheels. Such part-time transfer cases usually include a mechanical “mode” shift mechanism which can be selectively actuated by the vehicle operator for rigidly coupling the non-driven wheels to the driven wheels for establishing a part-time four-wheel drive mode. As will be appreciated, a motor vehicle equipped with a part-time transfer case offers the vehicle operator the option of selectively shifting between the two-wheel drive mode during normal road conditions and the part-time four-wheel drive mode for operation under adverse road conditions or for off road operation of the vehicle.

One problem with these automatic systems is that when power is applied to the front wheels and the transfer case is in the low range, i.e., the transmission is in first, second, or reverse, excessive wear occurs on the running gear which may lead to premature failure of the running gear components. While prior art systems allow the user to manually shift out of four wheel drive, they usually only shift automatically in response to road conditions or other stimuli.

U.S. Pat. No. 4,625,846 issued to Gomez discloses a device for disconnecting two drive wheels from an optional drive mechanism. The device does not disclose any means for discerning when the transmission is in the low range and does not shift in response to this stimuli.

U.S. Pat. No. 5,605,201 issued to McGinn discloses a system for converting from two wheel drive to four wheel drive based upon certain sensed conditions. By contrast, the present invention contemplates a system which converts from four wheel drive to two wheel drive when the transfer case is in the low range.

### SUMMARY OF THE INVENTION

The present invention provides an apparatus for automatically controlling the number of drive wheels to which power is applied in accordance with the range in which the transfer case is operated. In the low range of operation, including reverse, the drive power is supplied solely to the rear wheels. In the higher range, the number of drive wheels to which drive power is applied is in accordance with the operator settings. A pair of, for example, locking hubs that are actuated by vacuum, air or hydraulic power appropriately routed to the wheels and controlled by an electrically driven valve is operated, in conjunction with the transmission or transfer case shifting mechanism.

Accordingly, it is a principal object of the invention to provide an automatic front axle disconnect.

It is another object of the invention to provide an automatic front axle disconnect which disengages the front drive wheels in accordance with the range in which the transfer case is operated.

It is another object of the invention to provide an automatic front axle disconnect which uses an electrically controlled valve to disconnect a source of fluid pressure from locking hubs or other front wheel engaging mechanisms.

These and other objects of the present invention will become readily apparent upon further review of the following specification and drawings.

### BRIEF DESCRIPTION OF THE DRAWINGS

Various other objects, features, and attendant advantages of the present invention will become more fully appreciated as the same becomes better understood when considered in conjunction with the accompanying drawings, in which like reference characters designate the same or similar parts throughout the several views, and wherein:

FIG. 1 is a schematic representation of an exemplary four-wheel drive vehicle having a power transfer system within which the present invention may be incorporated.

FIG. 2 shows a plan view of the affected components of an exemplary vehicle incorporating the front axle disconnect of the present invention.

FIG. 3 shows a detailed diagrammatic view of the hardware components of the present invention.

### DETAILED DESCRIPTION

In general, the present invention is directed to a power transfer system which is operably installed between the driven and non-driven wheels of a four-wheel drive vehicle and which includes means for permitting a vehicle operator to select between a two-wheel drive mode, and a part-time four-wheel drive mode. When actuated, the inventive apparatus automatically causes the power transfer system to operate in the two-wheel drive mode, regardless of the status of the drive mode selection means.

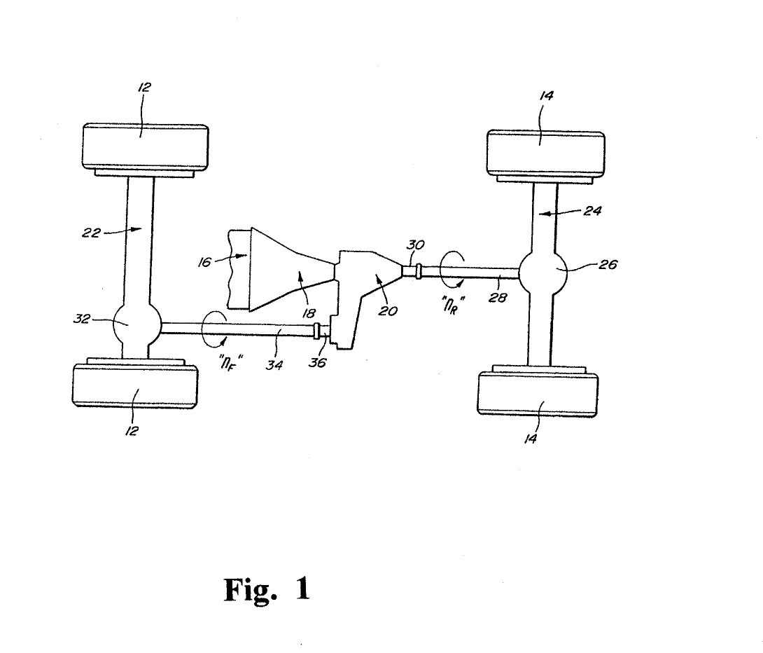

Referring to FIG. 1 of the drawings, a drivetrain for a four-wheel drive vehicle is schematically shown interactively associated with a power transfer system 10 which incorporates the novel principles of the present invention. The motor vehicle drivetrain has a pair of front wheels 12 and rear wheels 14 both drivable from a source of power, such as an engine 16, through a transmission 18 which may be of either the manual or automatic type. In the particular embodiment shown, the drivetrain is a rear wheel drive system which incorporates a transfer case 20 operable to receive drive torque from engine 16 and transmission 18 for normally driving rear wheels 14 (i.e., the “driven” wheels) in the two-wheel drive mode of operation. However, it is to be understood that the specific orientation of the drivetrain is merely exemplary in nature and that the drivetrain could be reversed for normally driving front wheels 12 in the two-wheel drive mode.

Front wheels 12 and rear wheels 14 are shown connected at opposite ends of front and rear axle assemblies 22 and 24, respectively. As is known, a rear differential 26 is interconnected between rear axle assembly 24 and one end of a rear drive shaft 28, the opposite end of which is interconnected to a first output member 30 of transfer case 20. Similarly, front axle assembly 22 includes a front differential 32 that is coupled to one end of a front drive shaft 34, the opposite end of which is coupled to a second output member 36 of transfer case 20. Transfer case 20 may be equipped with an electronically-controlled torque transfer arrangement for transferring drive torque to front wheels 12 (i.e., the “non-driven” wheels) in addition to rear wheels 14 for establishing the part-time four-wheel drive mode and the “on-demand” drive mode.

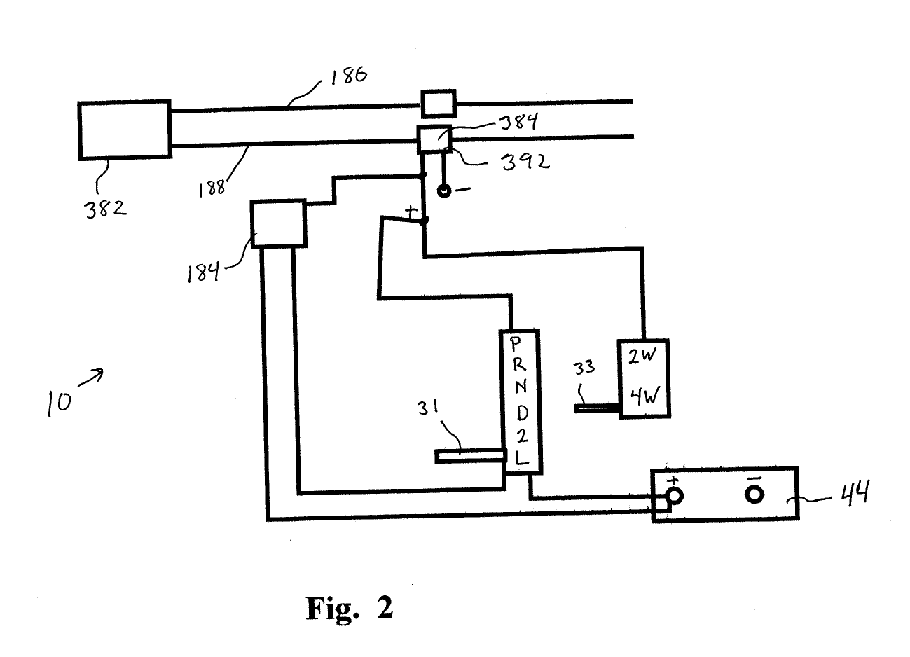

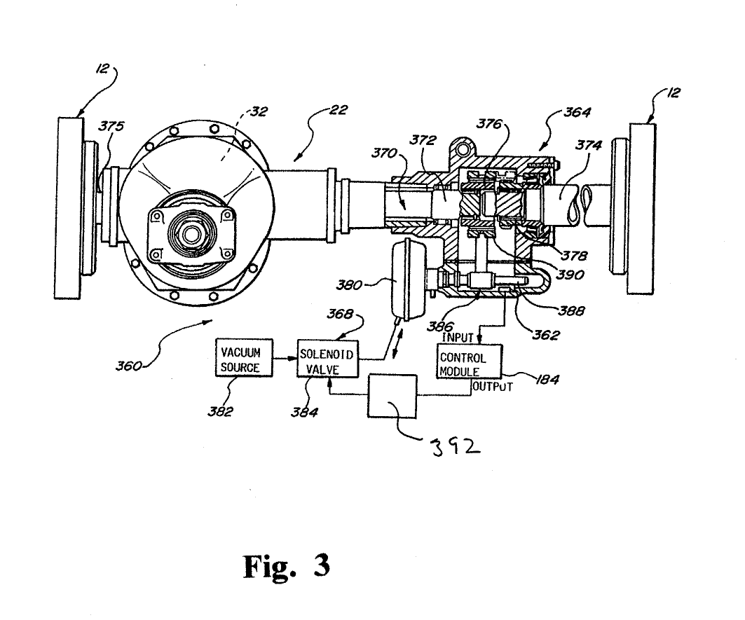

Referring now to FIGS. 2 and 3, there is shown a portion of an exemplary vehicle having a front axle assembly 22 which is pertinent to understanding the incorporation of axle disconnect system 360 into power transfer system 10 of the present invention. However, it is to be understood that the particular front axle assembly shown is merely illustrative in nature and is not intended to limit the present invention. The vehicle has a shift selector switch 31 for selecting the drive gear for the transmission (not shown) as well as a drive selector switch 33 for selecting the number of wheels, or axles to which drive power is applied.

In general, front axle assembly 22 includes front differential 32, axle connect mechanism 364, a shaft assembly 370 and front wheels 12. In particular, shaft assembly 370 has a first shaft 372 and that is coupled to drive or be driven by front differential 32, and a second shaft 374 that is coaxially aligned on a common longitudinal axis with first shaft 372 and rotatably connected to one of front wheels 12 in a conventional manner. As is also conventional, the other one of front wheels 12 is rigidly coupled by shaft 375 to drive or be driven by front differential 32 in a well known manner. Finally, a first clutch gear 376 is mounted for rotation with first shaft 372 while a second clutch gear 378 is mounted for rotation with second shaft 374.

Front axle disconnect system 360 has a first operating mode that is associated with two-wheel drive operation of the motor vehicle wherein first and second shafts 372 and 374, respectively, are not coupled together but rather are free to rotate independently of one another. In this first operating mode, rolling movement of front wheels 12 does not drive front differential 32. Thus, no rotary motion is transferred from front wheels 12 through differential 32 to front drive shaft 34 and front output 36, during motive operation of the motor vehicle. In addition, axle disconnect system 360 also has a second operating mode wherein shafts 372 and 374 are rigidly coupled for co-rotation such that front wheels 12 are coupled to front output 36 via front differential 32 and drive shaft 34. This second mode of operation is preferably associated with four-wheel drive operation of the motor vehicle.

Axle disconnect system 360 is shown to also include a vacuum motor 380 that is in fluid communication with a vacuum source 382, such as the vacuum from the intake manifold of engine 16. In the embodiment shown, front axle actuator 368 is an electronically-controlled solenoid valve 384 that can be selectively controlled for opening and closing a communication circuit between vacuum source 382 and vacuum motor 380. Axle connect mechanism 364 is shown to include a shift fork assembly 386 that is coupled to an axially movable output shaft 388 of vacuum motor 380 for axially shifting a clutch collar 390 between positions corresponding to the first and second operating modes of axle disconnect system 360. As seen, clutch collar 390 is retained for rotation with and axial sliding movement on first clutch gear 376. Thus, the axial position of shift fork assembly 386 and clutch collar 390 are controlled by the actuated condition of vacuum motor 380. In the first operating mode, clutch collar 390 is, as shown, located in a first or “de-coupled” position in engagement only with first clutch gear 376. In this position, shafts 372 and 374 are disconnected and front differential 32 is disconnected from front wheels 12. In the second operating mode, clutch collar 390 shifted to a second or “coupled” position (shown in phantom) for coupling first clutch gear 376 for rotation with second clutch gear 378, thereby connecting shafts 372 and 374 for common rotation. In this position, front differential 32 is capable of transferring power from the transfer case through the connected shafts to front wheels 12. In operation, control module 184 generates an output signal for selectively actuating solenoid control valve 384 for shifting vacuum motor shaft 388 between its retracted and extended positions which, in turn, causes corresponding movement of clutch collar 390 between its de-coupled and coupled positions. In accordance with a preferred embodiment of the invention, a 12 volt switch 392 is operated by control module 184 in response to the transfer case being operated in the low range.

Referring specifically to FIG. 2, a simplified arrangement of the vacuum lines in a typical vehicle having optional four wheel drive is shown. Line 186, commonly designated the red vacuum line, may be operatively connected to a main drive wheel engaging mechanism (not shown) for selectively disengaging the main drive wheels. Line 188, commonly designated the black vacuum line, is operatively connected to vacuum motor 380 for disengaging the front drive wheels as has been previously explained. Switch 392, which may be a solenoid switch or relay, allows for selective application of electrical power to electrically controlled valve 384 which may be a solenoid valve. As has been previously mentioned, a control module 184 sends control signals to switch 392 in response to the operation of the transfer case in the low range. Control module 184 is electrically connected to sensors or switches (not shown) associated with both shift selector 31 and drive selector 33. Alternatively, valve 384 may be operated in accordance with the position of the transmission shift selector 31 without the use of a control module. In this scenario, a pair of contacts (not shown) connected to the shift selector 31 close a circuit when the transmission, and therefor the transfer case, is operating in the low range, e.g., reverse, second or first. The circuit is connected between the battery 44 and the switch 392. Thus, the completion of the circuit between the shift selector contacts and the switch 392 takes the place of the control signal generated by control module 184. This arrangement obviates the need for a control module and increases overall system reliability.

In operation, when the shift selector 31 is in reverse, second, or first, the valve 384, either by virtue of control module 284 sensing the position of the shift selector 31 and sending the appropriate control signal to switch 392, or the closure of a switch connected to shift selector 31 which applies an activating voltage to switch 392 (from battery 44), disconnects the black vacuum line 188 from the vacuum motor 380 thereby disengaging the front drive wheels 12, regardless of the position of the drive selector 33 switch.

From the foregoing description, one skilled in the art can easily ascertain the essential characteristics of this invention and, without departing from the spirit and scope thereof, can make various changes and modifications of the invention to adapt it to various usages and conditions. For example, the invention may be employed with four-wheel drive vehicles where selection of the number of drive wheels is a function of predetermined operator-initiated inputs. In this scenario, when the drive selector is in “conditional” 4 wheel drive mode, connection of the second pair of drive wheels would be prevented even when the predetermined inputs are sensed

It is to be understood that the present invention is not limited to the sole embodiment described above, but encompasses any and all embodiments within the scope of the following claims:

What is claimed is:

1. A front axle disconnect system for a vehicle having at least first and second pairs of wheels to which drive power may be applied comprising:
a source of fluid pressure, said source of fluid pressure operatively connected to an axle disconnect mechanism via a fluid pressure conduit, said mechanism capable of selectively disconnecting either said first or second pairs of drive wheels from a source of motive power;
a shift selector mechanism for selecting a drive gear to which said source of motive power is coupled and a drive selector for selecting which of said first and second pairs of drive wheels to which said motive power is applied;
a valve means coupled to said fluid pressure conduit, said valve means capable of interrupting fluid pressure to said axle disconnect mechanism thereby disconnecting either said first or second pairs of drive wheels from the source of motive power, wherein said valve means is operated in response to positioning of said shift selector mechanism.

2. The front axle disconnect system of claim 1 including a control module connected to said valve means, said control module having means for sensing positioning of said shift selector.

3. The front axle disconnect system of claim 2 wherein said control module outputs a control signal in response to the positioning of the shift selector, said control signal causing operation of a switch operably connected to said valve means, whereby either said first or second pairs of drive wheels are disconnected from said source of motive power in response to said shift selector being in a predetermined position.

4. The front axle disconnect system of claim 3 wherein said shift selector can be positioned to select one of several gears including a first gear, a second gear, and a reverse gear, and wherein said predetermined position is either said first gear, said second gear or said reverse gear.

5. The front axle disconnect system of claim 1 wherein said first pair of wheels correspond to a rear portion of said vehicle, said first pair of wheels being main drive wheels, and wherein said valve means disconnects said second pair of drive wheels in response to the position of the shift selector switch.
